(19) United States
(12) Patent Application Publication
(10) Pub. No.: US 2011/0235700 A1
(43) Pub. Date: Sep. 29, 2011

(54) APPARATUS AND METHOD FOR GENERALIZED FGS TRUNCATION OF SVC VIDEO WITH USER PREFERENCE

(75) Inventors: Truong Cong Thang, Daejeon (KR); Jung Won Kang, Daejeon (KR); Jeong Ju Yoo, Daejeon (KR); Jin Woo Hong, Daejeon (KR)

(73) Assignee: Electronics and Telecommunications Research Institute, Daejeon (KR)

(21) Appl. No.: 12/809,366

(22) PCT Filed: Oct. 7, 2008
(86) PCT No.: PCT/KR2008/005884

§ 371 Date: Jun. 18, 2010

(30) Foreign Application Priority Data
Dec. 18, 2007 (KR) 10-2007-0133225
Feb. 14, 2008 (KR) 10-2008-0013494

(51) Int. Cl. H04N 7/26

(52) U.S. Cl. 375/240.02; 375/E07.127

(57) ABSTRACT

An apparatus for truncating fine granular scalability (FGS) data of a scalable video coding (SVC) video, the apparatus including: a rate-distortion (R-D) data extractor analyzing a bitstream to extract R-D data of at least one spatial layer; a user preference collector collecting user preference information associated with each spatial layer; a decision engine unit deciding an optimal bitrate of each spatial layer based on the R-D data and the collected user preference information; and a scaling engine unit truncating FGS data that does not correspond to the optimal bitrate of each spatial layer is provided.

### TECHNICAL FIELD

The present invention relates to an apparatus and method of truncating fine granular scalability (FGS) data, and more particularly, to an apparatus and method of optimally adapting FGS data in order to maximize the overall quality information of a video when a scalable video bitstream including a spatial resolution corresponding to at least one spatial layer is transmitted to a plurality of users.

This work was supported by the IT R&D program of MIC/IITA. [2005-S-103-03, Development of Ubiquitous Content Access Technology for Convergence of Broadcasting and Communications]

### BACKGROUND ART

A scalable video coding (SVC) scheme is a promising video format for applications of multimedia communication. The SVC scheme that is extended from the latest advanced video coding (AVC) scheme is appropriate to create a wide variety of bitrates with high compression efficiency.

An original SVC bitstream may be easily truncated in different manners to meet various characteristics and variations of devices and connections and may provide scalability in various dimensions.

The scalability may be possible in three dimensions, namely spatial, temporal, and a signal-to-noise ratio (SNR). The SVC bitstream provides scalability in each dimension.

Fine granular scalability (FGS) data of SNR scalability can be truncated arbitrarily to meet the bitrate constraint of connection. Generally, the FGS data is truncated in a top-down manner, that is, starting from a top spatial layer to a down spatial layer.

Currently, the above-described FGS data of the bitstream may be truncated using a plurality of approaches. One is top-down truncation approach where the down spatial layer gets the best possible quality while the higher spatial layer may be much degraded. This may be also referred to as bottom-max approach. In another approach, a portion of FGS data of a lower spatial layer may be removed so that the top spatial layer may have the best possible quality at all times. This may be also referred to as top-max approach.

In the case of the existing approaches, there is a disadvantage in that quality information of a single spatial layer may be maximized, whereas quality information of another spatial layer may be degraded significantly. Also, there is another disadvantage in that requirements from a user may be complex and variant over time, whereas all the requirements may not be accepted.

### DISCLOSURE OF INVENTION

### Technical Problem

An aspect of the present invention is to provide a scalable video coding (SVC) bitstream to be appropriate for consumption environments, wherein the SVC bitstream includes at least one spatial layer, that is, resolution, and fine granular scalability (FGS) data providing signal-to-noise ratio (SNR) scalability to each spatial layer.

Also, another aspect of the present invention is to define quality information associated with at least one spatial layer as a function and to enable the quality information to be changed while the overall quality information is being transmitted.

Also, another aspect of the present invention is to flexibly assign resources to each spatial layer using a framework proposed in the present invention.

### Technical Solution

According to an aspect of the present invention, there is provided an apparatus for truncating fine granular scalability (FGS) data of a scalable video coding (SVC) video, the apparatus including: a rate-distortion (R-D) data extractor analyzing a bitstream to extract R-D data of at least one spatial layer; a user preference collector collecting user preference information associated with each spatial layer; a decision engine unit deciding an optimal bitrate of each spatial layer based on the R-D data and the collected user preference information; and a scaling engine unit truncating FGS data that does not correspond to the optimal bitrate of each spatial layer.

In this instance, the R-D data extractor may extract quality information according to a bitrate of a lower spatial layer among the at least one spatial layer and a bitrate of the corresponding spatial layer.

Also, the decision engine unit may decide the overall quality information according to a Viterbi algorithm of a dynamic programming.

Also, the decision engine unit may extract information restricted by at least one of the identifier information, the weight, and the minQuality information or the maxQuality information that are included in the user preference information.

Also, the scaling engine unit may simultaneously truncate FGS data of the at least one spatial layer.

According to another aspect of the present invention, there is provided a method of truncating FGS data of a SVC video, the method including: analyzing a bitstream to extract R-D data of at least one spatial layer; collecting user preference information associated with each spatial layer; deciding an optimal bitrate of each spatial layer based on the R-D data and the collected user preference information; and truncating FGS data that does not correspond to the optimal bitrate of each spatial layer.

### Advantageous Effects

According to the present invention, it is possible to provide a scalable video coding (SVC) bitstream to be appropriate for consumption environments, wherein the SVC bitstream includes at least one spatial layer, that is, resolution, and fine granular scalability (FGS) data providing signal-to-noise ratio (SNR) scalability to each spatial layer.

Also, according to the present invention, it is possible to define quality information associated with at least one spatial layer as a function and to enable the quality information to be changed while the overall quality information is being transmitted.

Also, according to the present invention, it is possible to flexibly assign resources to each spatial layer using a framework proposed in the present invention.

### BRIEF DESCRIPTION OF THE DRAWINGS

FIG. 1 is a block diagram illustrating a configuration of an apparatus for truncating fine granular scalability (FGS) data of a scalable video coding (SVC) video according to an embodiment of the present invention;

FIG. 2 illustrates an example of two spatial layers in an SVC bitstream according to an embodiment of the present invention;

FIG. 3 illustrates syntax of user preference information according to an embodiment of the present invention;

FIG. 4 illustrates semantics associated with syntax of user preference information according to an embodiment of the present invention;

FIG. 5 is a flowchart illustrating a method of truncating FGS data of a SVC video according to an embodiment of the present invention; and

FIG. 6 is a flowchart illustrating a method of determining and truncating FGS data according to an embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

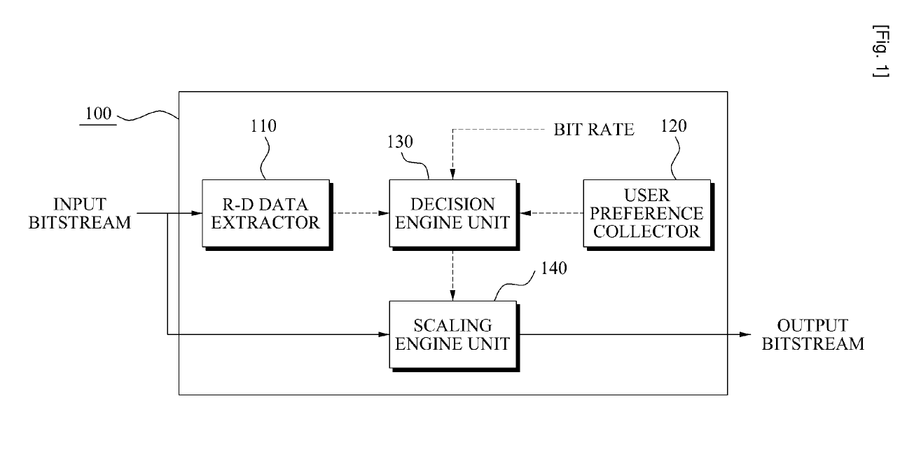

FIG. 1 is a block diagram illustrating a configuration of a fine granular scalability (FGS) data truncating apparatus 100 of a scalable video coding (SVC) video according to an embodiment of the present invention.

In order to maximize the overall quality information associated with spatial layers provided by an adapted bitstream, the present invention considers truncating of FGS data of an SVC bitstream including at least one spatial layer.

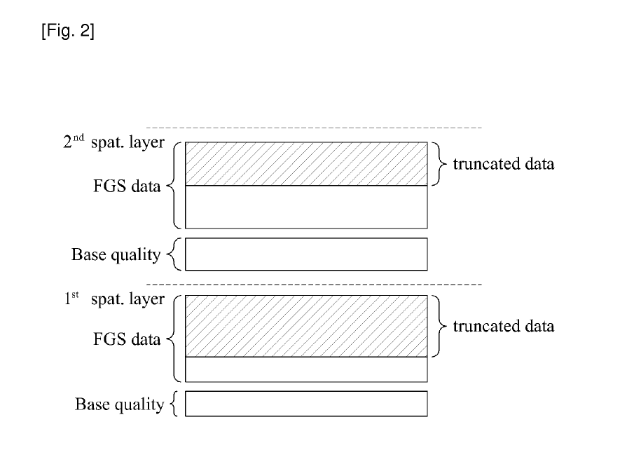

FIG. 2 illustrates an example of two spatial layers in an SVC bitstream according to an embodiment of the present invention.

For example, as shown in FIG. 2, a surveillance video may include two spatial layers. Each of the spatial layers may be encoded in an SVC format and enhanced by FGS data. In this instance, the surveillance video may be streamed to a remote building where two users may consume contents.

Specifically, when a first user has a personal computer (PC) that can decode the top spatial layer and a second user has a personal digital assistant (PDA) that can decode the bottom spatial layer, the FGS data needs to be truncated in order to meet a connection bandwidth, that is, a connection bitrate of the building. An amount of FGS data to be truncated may occupy a large portion of the total bitrate of the bitstream.

According to an aspect of the present invention, there is provided a method that can provide an SVC bitstream to be appropriate for consumption environments, wherein the SVC bitstream includes at least one spatial layer, that is, resolution, and FGS data providing signal-to-noise ratio (SNR) scalability to each spatial layer. Hereinafter, the configuration of the FGS data truncating apparatus 100 for performing the above method will be sequentially described.

Initially, a rate-distortion (R-D) data extractor 110 may analyze a bitstream to extract R-D data of at least one spatial layer.

The input bitstream may be initially sent to the R-D data extractor 110 of providing R-D data of each spatial layer.

Also, the R-D data may include quality information according to a bitrate that is decided for each spatial layer. Quality information may be greater than or equal to minQuality information and less than or equal to maxQuality information. The overall quality information corresponding to a sum of the quality information may be determined by a weighted sum of quality information associated with each spatial layer.

In this instance, R-D data of layer i may be expressed as Qᵢ=f(Rᵢ, Rᵢ₋₁, . . . , R₁) where Rᵢ denotes a bitrate of the spatial layer i and Qᵢ denotes quality information associated with the spatial layer i. Specifically, due to the interlayer prediction of SVC, quality information associated with a single spatially layer may depend on quality information/bitrate of a lower spatial layer as well as bitrate of the corresponding spatial layer.

Accordingly, the R-D data extractor 110 may determine quality information associated with each spatial layer based on the bitrate(s) of lower spatial layer(s) and the bitrate of the corresponding spatial layer.

According to an aspect of the present invention, when i=1, the spatial layer may denote the down spatial layer. The R-D data relationship may be represented using either sampling points in a discrete form or analytical functions in a continuous form. For example, different amounts of bitrates may be simultaneously discarded in all the spatial layers. Then, corresponding quality information associated with each spatial layer may be measured. Generally, analytic functions of the R-D data may obtained from sampling points using a regression scheme.

Also, in order to reduce overhead in R-D data extraction, it is possible to classify video contents into different classes according to features of each video content. Each class may be controlled to have a common set of R-D data.

In this instance, a new video content may be assigned to a single class and may also be associated with class-specific R-D data. A function of the quality information may be objective, for example, peak-signal-to-noise ratio (PSNR) and mean squared error (MSE), may be subjective (MOS), or may be perceptual based on a model of a human visual system.

Specifically, a framework according to the present invention may provide a generalized system for various types of methods of extracting or expressing R-D data and various types of quality information.

Although it generally takes time to obtain R-D data of a bitstream, the R-D data may be extracted in non-real time offline to be used for real-time adaptation online and the like.

According to an aspect of the present invention, the R-D data may be stored in a form of metadata associated with the corresponding bitstream. A standard metadata tool for the R-D data may be, for example, AdaptationQoS of MPEG-21 DIA.

According to an aspect of the present invention, characteristics of a video sequence, for example, motion activity, spatial complexity, and the like may be changed over time. Thus, it may be not possible to sufficiently express characteristics of a video using only a single R-D data set. However, in this case, it is possible to sufficiently express the characteristics of the video by dividing the video sequence into a plurality of consecutive segments, each will be associated with R-D data of each segment.

The user preference collector 120 may collect user preference information associated with each spatial layer.

The user preference information may include various types of information such as identifier information associated with a spatial layer of the bitstream, a weight corresponding to importance information of the spatial layer, and minQuality information or maxQuality information that is desired by a user using the FGS data truncating apparatus 100 among the quality information associated with each spatial layer.

In this instance, for example, a single weight value among the user preference information may be assigned to each spatial layer and a default value may be set to “1”. As the weight value increases, adapted quality information of a corresponding spatial layer may be improved.

Also, users may not accept quality information less than minQuality information. Quality information greater than maxQuality information may be unnecessary for a user. However, the user may not care whether an adaptive system provides the quality information greater than the maxQuality information.

The maxQuality information and the minQuality information may be used to reduce a solution searching time. Since the weight value is a relative value, the default value may be set to a predetermined value by a provider.

Also, parameters of the user preference information tool may be adjusted by the user via a graphical user interface (GUI), or may be automatically adjusted by machine learning using a user profile, user behavior/history, etc.

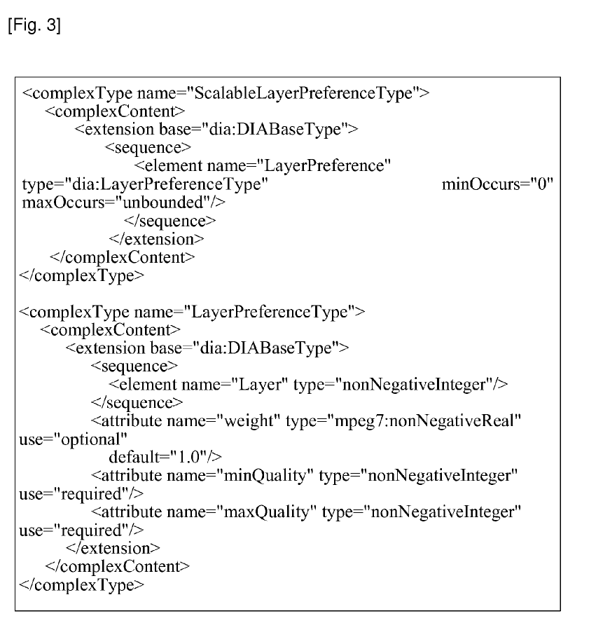

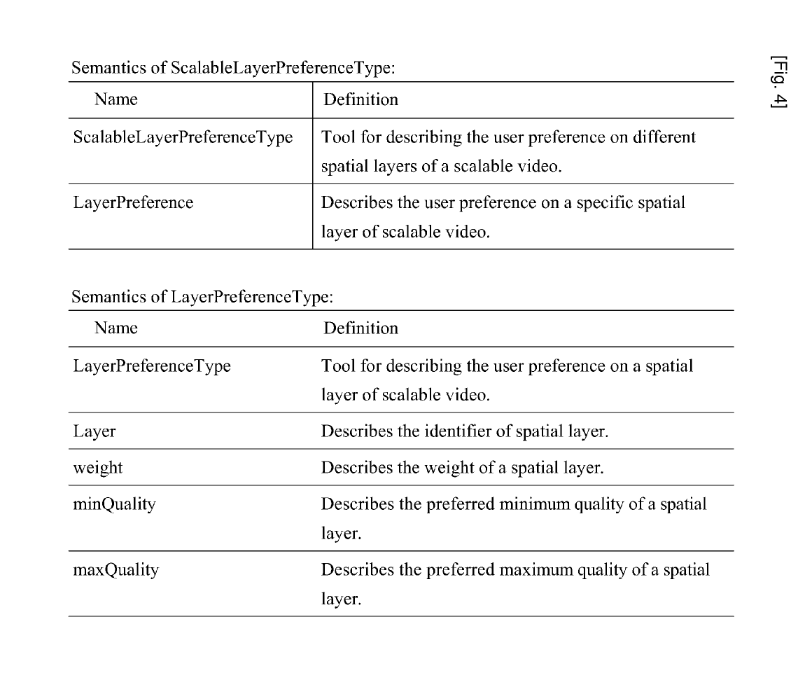

FIG. 3 illustrates syntax of user preference information according to an embodiment of the present invention, and FIG. 4 illustrates semantics associated with syntax of user preference information according to an embodiment of the present invention.

Parameters of user preference information may be changed during a session. A decision engine unit 130 of FIG. 2 may transfer its changed instructions to a scaling engine unit 140. The above flow may be performed in real time. The syntax and semantics of the user preference information will be described in detail with reference to FIGS. 3 and 4.

The user preference information may be collected by a user preference collector 120 and be transmitted to the decision engine unit 130. The decision engine unit 130 may determine an optimal adaptive scheme based on the collected user preference information.

The decision engine unit 130 may decide an optimal bitrate of each spatial layer based on the R-D data and the collected user preference information.

Specifically, the decision engine unit 130 may decide an amount of bitrate to be discarded from each spatial layer in order to maximize the overall quality information of a bitstream.

According to an aspect of the present invention, the overall quality information of the bitstream may be determined by considering a plurality of users consuming different spatial layers of a corresponding bitstream, or by considering a single user consuming the bitstream.

In this instance, OQ denotes the overall quality information of the truncated bitstream, N denotes the number of spatial layers, Qᵢ^{min} and Qᵢ^{max} denote the minQuality information and maxQuality information that are required for spatial layer i, respectively, and R^{c} denotes a bitrate constraint of the whole bitstream.

Also, Rᵢ^{max} denotes a maximum bitrate of the layer i and may be determined by capability of a terminal or a connection that is used to consume the layer i. Specifically, an adaptation problem may be formulated as follows.

Initially, find the set {Rᵢ} that satisfies the following conditions and maximizes OQ, subject to

$${\sum }_{i = 1}^{N} {R}_{i} \leq {R}^{c} and$$

$${R}_{i} \leq {R}_{i}^{max}$$

Qᵢ^{max}≧Qᵢ≧Qᵢ^{min} [Equation 1]

where i=1 . . . , N.

Accordingly, the overall quality information may be defined by,

$$OQ = {\sum }_{i = 1}^{N} {w}_{i} \cdot {Q}_{i} , \qquad [ Equation 2 ]$$

where wᵢ denotes the weight of the layer i.

According to an aspect of the present invention, it is possible to adjust harmonization of quality information between different spatial layers using the above Equation 2 by changing values of wᵢ. For example, if w₁=1 and w₂=0, truncation will be performed from the top layer to the down layer, that is, in a top-down order so that the first spatial layer has the best possible quality at all times.

In order to solve the above problem, when Qᵢ^{min} is not specified, it is possible to suppose that Qᵢ^{min} is equal to the quality information of base quality information of the corresponding spatial layer. When Qᵢ^{max} is not specified, it is possible to suppose that Qᵢ^{max} is equal to original quality information of the corresponding spatial layer.

According to an aspect of the present invention, an SVC video content may be truncated in byte units, which means that when R-D data is represented as analytical functions, the R-D data may be discretized without affecting quality information performance.

Accordingly, the above problems may be solved using a particular algorithm of dynamic programming. A particular algorithm may be, for example, a Viterbi algorithm. The present invention may adopt a fast approximation scheme of the Viterbi algorithm or dynamic programming.

In all the above cases, when a number of spatial layers of the SVC bitstream is not large, computation of the Viterbi algorithm may be performed in real time.

The scaling engine unit 140 may truncate FGS data that does not correspond to the optimal bitrate of each spatial layer.

The decision engine unit 130 may output bitrates of spatial layers and the scaling engine unit 140 may truncate FGS data at different spatial layers. In this instance, the FGS data may be truncated from each spatial layer to meet the bitrate budget of the corresponding spatial layer.

The FGS data may be truncated using various schemes. For example, the FGS data of all the time stamps may be truncated at the same ratio, regardless of temporal levels.

According to another aspect of the present invention, there is proposed a scheme that can truncate FGS data in a descending order of temporal levels.

In this instance, it is premised that when more than one FGS layer exists in each spatial layer, FGS data is truncated in a top-down manner, that is, in an order from the top FGS layer to the down FGS layer.

The scaling engine unit 140 may truncate FGS data of the at least one spatial layer.

The optimal bitrate decided by decision engine unit 130 may be either an adapted bitrate or an discarded bitrate. The scaling engine unit 140 may be controlled according to either the adapted bitrate or the discarded bitrate.

Also, according to an aspect of the present invention, there may be further provided a decoding apparatus for decoding the output bitstream that is adapted (i.e. extracted) according to the optimal bitrate(s) of the spatial layer(s).

Specifically, the decoding apparatus may include a receiver receiving the adapted bitstream from an FGS data truncating apparatus, a decoder decoding the adapted bitstream, and a user preference information maintaining unit maintaining user preference information associated with the at least one spatial layer in order to transmit the user preference information to the FGS data truncating apparatus.

In this instance, the user preference information associated with the at least one spatial layer may include identifier information associated with a layer corresponding to a spatial layer of the bitstream, a weight corresponding to importance information of the spatial layer, and minQuality information or maxQuality information.

As described above, the FGS data truncating apparatus may include an R-D data extractor analyzing a bitstream to extract R-D data of at least one spatial layer, a user preference collector collecting user preference information associated with each spatial layer, a decision engine unit deciding an optimal bitrate of each spatial layer based on the R-D data and the collected user preference information, and a scaling engine unit truncating FGS data that does not correspond to the optimal bitrate of each spatial layer.

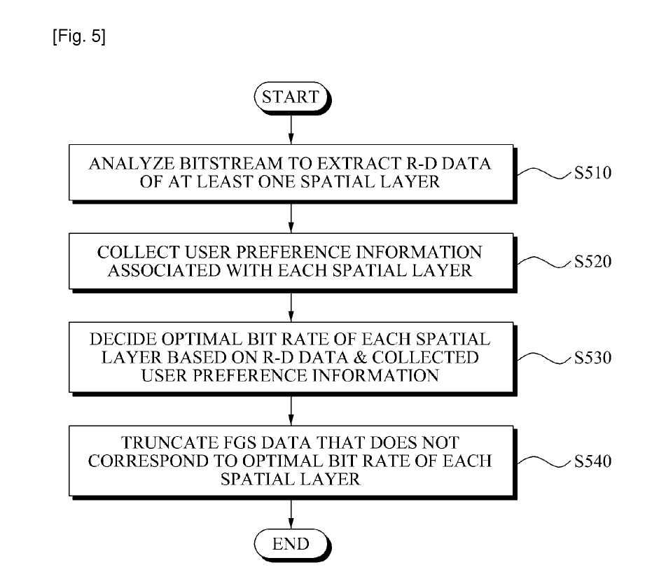

FIG. 5 is a flowchart illustrating a method of truncating FGS data of a SVC video according to an embodiment of the present invention.

The method of truncating FGS data of the SVC video according to the present embodiment may be performed by the FGS data truncating apparatus 100. Hereinafter, the method may be sequentially described based on a functional aspect of a system adopting the present invention.

The method may be performed by the FGS data truncating apparatus 100 and thus include all the functional elements of the FGS data truncating apparatus 100. Therefore, detailed descriptions related thereto will be omitted or will be briefly described.

In operation S510, the R-D data extractor 110 may analyze a bitstream to extract R-D data of at least one spatial layer.

Also, the R-D data may include quality information according to a bitrate that is decided for each spatial layer. Quality information may be greater than or equal to minQuality information and less than or equal to maxQuality information. The overall quality information corresponding to a sum of the quality information may be determined by a weighted sum of quality information associated with each spatial layer.

In operation S520, the user preference collection 120 may collect user preference information associated with each spatial layer.

In this instance, the user preference information may be adjusted by the user via a GUI, or may be automatically adjusted by mechanical learning using a user profile, user habits, or user patterns.

The user preference information may include various types of information such as identifier information associated with a spatial layer of the bitstream, a weight corresponding to importance information of the spatial layer, and minQuality information or maxQuality information that is desired by a user among the quality information associated with each spatial layer.

In operation S530, the decision engine unit 130 may decide an optimal bitrate of each spatial layer based on the R-D data and the collected user preference information.

Operation S530 may be an operation to decide an amount of bitrate to be discarded from each spatial layer using the decision engine unit 130 in order to maximize the overall quality information of the bitstream.

In operation S540, the scaling engine unit 140 may truncate FGS data that does not correspond to the optimal bitrate of each spatial layer.

Also, in operation S540, the decision engine unit 130 may output bitrates of spatial layers and the scaling engine unit 140 may truncate FGS data of different spatial layers. In this instance, the FGS data may be truncated from each spatial layer to meet the bitrate budget of the corresponding spatial layer.

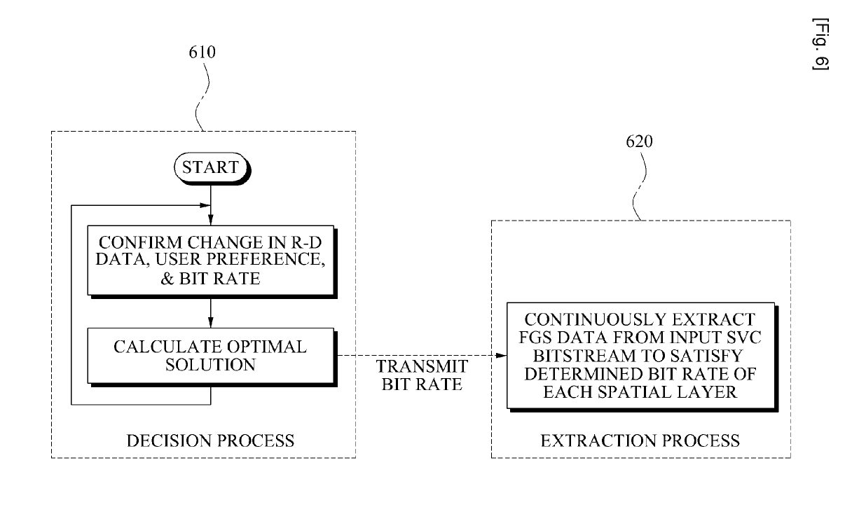

FIG. 6 is a flowchart illustrating a method of determining and truncating FGS data according to an embodiment of the present invention.

The method may include a decision process 610 and an extraction process 620.

Although an R-D data extraction process may also need to be included, this operation is generally performed offline and thus will be omitted from the figure.

The decision process 610 may continuously confirm change in R-D data, for example, a new segment, a user preference, a bitrate limit, and the like, and may compute or re-compute an optimal solution using the above Equation 1.

The extraction process 620 may continuously truncate FGS data from an input SVC bitstream to satisfy a determined bitrate of each spatial layer.

According to an aspect of the present invention, the decision process 610 and the extraction process 620 may be simultaneously performed.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The hardware device may be constructed to function as at least one software module, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for truncating fine granular scalability (FGS) data of a scalable video coding (SVC) video, the apparatus comprising:
a rate-distortion (R-D) data extractor analyzing a bitstream to truncate R-D data of at least one spatial layer;
a user preference collector collecting user preference information associated with each spatial layer;
a decision engine unit deciding an optimal bitrate of each spatial layer based on the R-D data and the collected user preference information; and
a scaling engine unit truncating FGS data that does not correspond to the optimal bitrate of each spatial layer.

2. The apparatus of claim 1, wherein the user preference information comprises:
identifier information associated with a spatial layer of the bitstream;
a weight corresponding to importance information of the spatial layer; and
minQuality information or maxQuality information that is determined according to user request information.

3. The apparatus of claim 2, wherein:
the R-D data comprises quality information according to the bitrate that is decided for each spatial layer,
the quality information is greater than or equal to the minQuality information and less than or equal to the maxQuality information, and
the overall quality information corresponding to a sum of the quality information is determined by a weighted sum of quality information associated with each spatial layer.

4. The apparatus of claim 3, wherein the R-D data extractor extracts quality information according to the bitrate(s) of lower spatial layer(s) and the bitrate of the corresponding spatial layer.

5. The apparatus of claim 1, wherein the R-D data is provided using any either sampling points in a discrete form or analytical functions in a continuous form.

6. The apparatus of claim 1, wherein the quality information associated with the R-D data can be any type of quality metric.

7. The apparatus of claim 3, wherein the decision engine unit decides the overall quality information according to a particular algorithm of a dynamic programming.

8. The apparatus of claim 3, wherein the decision engine unit receives, from the user preference collector, information restricted by at least one of the identifier information, the weight, and the minQuality information or the maxQuality information that are included in the user preference information.

9. The apparatus of claim 3, wherein a result value of the decision engine unit is changed based on the user preference information, bitrate constraint, and R-D data of input bitstream.

10. The apparatus of claim 1, wherein the scaling engine unit simultaneously truncates FGS data of the at least one spatial layer.

11. The apparatus of claim 1, wherein:
the decision engine unit may output either adapted (extracted) bitrates or discarded bitrates, and
accordingly the scaling engine unit is controlled by either the adapted bitrates or the discarded bitrates.

12. The apparatus of claim 10, wherein the scaling engine unit truncates FGS data in an order from the top FGS data layer to the down FGS data layer of each spatial layer.

13. The apparatus of claim 1, wherein the input bitstream may have any configurations, such as any ratio of spatial scalability, any frame rate for a given spatial layer, with or without dead-substream.

14. The apparatus of claim 1, wherein the FGS data truncating apparatus transmits and receives information in real time or in non-real time.

15. An apparatus for decoding FGS data of a SVC video, the apparatus comprising:
a receiver receiving an adapted bitstream from an FGS data truncating apparatus;
a decoder decoding the adapted bitstream; and
a user preference information maintaining unit maintaining user preference information associated with the at least one spatial layer in order to transmit the user preference information to the FGS data truncating apparatus.

16. The apparatus of claim 15, wherein the user preference information associated with the at least one spatial layer comprises:
identifier information associated with a layer corresponding to a spatial layer of the bitstream;
a weight corresponding to importance information of the spatial layer; and
minQuality information or maxQuality information.

17. A method of truncating FGS data of a SVC video, the method comprising:
analyzing a bitstream to extract R-D data of at least one spatial layer;
collecting user preference information associated with each spatial layer;
deciding an optimal bitrate of each spatial layer based on a bitrate included in the R-D data and the collected user preference information; and
truncating FGS data that does not correspond to the optimal bitrate of each spatial layer.

18. The method of claim 17, wherein the user preference information comprises:
identifier information associated with a layer corresponding to a spatial layer of the bitstream;
a weight corresponding to importance information of the spatial layer; and
minQuality information or maxQuality information.

19. The method of claim 18, wherein:
the R-D data comprises quality information according to the bitrate that is decided for each spatial layer,
the quality information is greater than or equal to the minQuality information and less than or equal to the maxQuality information, and
the overall quality information corresponding to a sum of the quality information is determined by a weighted sum of quality information associated with each spatial layer.

20. The method of claim 19, wherein the quality information of the spatial layer is determined based on a bitrate of a lower spatial among the at least one spatial layer, a bitrate of a corresponding spatial layer, and the user preference information.
